(19) United States
(12) Patent Application Publication
(10) Pub. No.: US 2005/0061188 A1
(43) Pub. Date: Mar. 24, 2005

(54) Method and device for measuring and regulating the concentrations of chemical compounds in processing liquids for offset printing

(75) Inventors: Gunther Krieg, Karlsruhe (DE); Joop van Hesteren, Roosendaal (NL)

Correspondence Address: Lichti + Partner GbR;Patentanwalte, Bergwaldstr. 1, Karlsruhe, D-76227, DE

(73) Assignee: Fuji Hunt Photographic Chemicals, Sint-Niklaas (BE)

(21) Appl. No.: 10/895,388

(22) Filed: Jul. 21, 2004

(30) Foreign Application Priority Data
Jul. 24, 2003 (DE) DE 103 33 625.7

(51) Int. Cl. B41F 1/54

(52) U.S. Cl. 101/484

(57) ABSTRACT

The invention concerns a method and a device for measuring and regulating the concentrations of chemical compounds in a processing liquid for offset printing, wherein the concentrations of the individual chemical components are detected online by a measuring system and are redosed by a regulating system such that the respective desired value of each individual component in the processing liquid is realized at all times.

In offset printing machines, the respective printing plate is wet with an aqueous liquid using a so-called dampening device to ensure that the image regions accept the ink and the image-free regions repel the ink during a subsequent processing step. The aqueous liquid is often a mixture comprising alcohol, in addition to water. Isopropanol is mostly used, and is referred to below as an additive. The additive is added in concentrations between 1 and 8 vol % and the alcohol between 0.5 and 20 vol %. The concentration of water is therefore between 72% and 98.5 vol %. If optimized additives are used, alcohol is sometimes completely omitted. In this case, the additive is also called an alcohol substitute. The optimized additive assumes the function of the isopropanol either completely or partially.

One major problem in offset printing is the insufficient up-time of the machine which is typically only approximately 80% and is therefore characterized by long down-times for these very expensive printing machines. One could e.g. save approximately 35,000.00 Euros per year if the pure productive time per day of a so-called 64 page rotary offset printing system could merely be increased by an average of two minutes. New, intensive practical examinations have clearly shown that the insufficient up-time of offset printing machines is essentially due to the undefined, unknown physical and chemical composition of the processing liquid which cannot be measured to date and therefore cannot be regulated. These experiments showed, in a particular and paradoxical manner, that even if a predetermined volumetric mixture of the water and additive components is precisely realized, e.g. through exact control of two dosing pumps which inject e.g. volumes of 97 vol % water and 3 vol % additive into the processing liquid, a much lower value is actually present in the processing liquid circuit, e.g. 0.8 vol % of additive. Even more surprising, analyses have shown that the original percentage composition of the individual components of the additive in the dampening solution circuit do not correspond to the originally targeted composition realized by the dosing pumps through controlled feeding. Processes take place (“cannibalistic effects”) with which the components of the additive vanish during the printing process to a greater or lesser degree although they are added periodically in accordance with the targeted concentration proportions. In current conventional offset printing technology, the additive concentrate is introduced in the form of one single chemical mixture which consists of all required chemical components in precisely predetermined concentrations. The composition depends on the amount of applied pressure, i.e. roller offset, sheet-fed offset or newspaper printing and on the type of machine, paper, ink, as well as on the dampening solution circuit of the printing machine. This procedure is inadequate and does not meet modern requirements for high offset process up-time. Although these disadvantages can be compensated for to a certain degree in printing with alcohol by adding higher concentrations of isopropanol as is current practice, this procedure cannot be regarded as a technical solution for the future, since isopropanol, being a solvent and volatile component (VOC=volatile organic compound), is prohibited in offset printing in many US states, subject to strict laws for emission reduction in Europe, and even fined in Switzerland with a penalty tax, the so-called “Lenkungsabgabe”, which is detrimental to the economics of the printing process. For environmental political reasons and, in particular, in order to also protect the health of the printers at their workplace, isopropanol or other solvents must be substantially reduced or completely eliminated in future printing processes. The concentrations of alcohol in the dampening solution are currently generally between 6% and 20% and facilitate the use of so-called film dampening devices in roller and sheet-fed offset printing. In accordance with prior art, the film dampening devices comprise several rollers which are coated with rubber mixtures and/or metals and are rotated together in contact with each other under a slight pressure to transport the dampening solution, in the form of a film of adjustable film thickness, to the printing plate. This transport process is facilitated by the addition of isopropanol due to the reduction of surface tension of the liquid film caused thereby. In addition to conventional film dampening devices, contact-free operating systems, in particular, spray dampening devices operating with nozzles, or dampening devices comprising rollers jacketed with plush are also used. In these cases, the dampening means is transported without continuous liquid film, and use of alcohol may therefore be omitted. The new inventive method is also of great importance for conventional designs, since it permits optimum composition of chemicals in the dampening solution.

To meet the legal constraints regarding the ban of isopropanol, other solvents were marketed in particular in the U.S.A. This was not the case in Europe since this solution does not eliminate the use of solvents. Moreover, some of the other solvents are assumed to cause cancer or be detrimental to health and therefore do not constitute an alternative to alcohol.

A real alternative to alcohol are the so-called tensides which achieve comparable advantages with regard to the wetting properties of the dampening solution on the rollers of the dampening device. It must be noted, in particular, that tensides are not VOCs. Experience has shown that these positive tenside properties may be utilized only if the required targeted concentrations can be accurately met. In the currently used conventional alcohol-free methods, tensides produce undesired foams and emulsification of ink and dampening solution which reduces quality, such that, in many practical applications, printing without alcohol fails and must be replaced by printing with alcohol. This is further complicated by the fact that tensides in a chemical multi-component mixture often only dissolve with great difficulty, which requires the addition of solvents into the additive concentrate to prevent separation, i.e. deposit on the bottom of the additive container of the supplier. This difficulty is also easily solved by the inventive method, which provides the possibility of applying only those chemical substance components which are absolutely necessary for the printing process. Since the sheet speeds of modern printing machines are constantly increasing, increasingly precise measurement and dosing of the individual chemical components are required. The inventive method is therefore essential to printing without alcohol. This is supported by the fact that, with exactly the same printing machine, the composition of the individual components of the additive must be variable—depending on the printing orders i.e. on the paper, the particular inks required by the specific customer, the specially used rubber blanket, the roller coating, etc. This is only possible with the new method described herein. This is particularly true since there is no single additive anywhere in the world today which permits printing without alcohol under all conditions which occur in a printing machine. This explains why printing managers want to repeatedly test other additive formulations to realize their printing orders. Nevertheless, each chemical formulation is a compromise and is therefore optimum only for a limited range of printing orders. In total, the current conventional procedure is very expensive and renders printing without alcohol impossible in practice, despite the above-mentioned legal regulations in Europe.

It is therefore the object of the present invention to readjust to the respective target values through continuous measurement and regulation of the composition of the dampening solution, i.e. through continuous redosing of the individual, differently decreasing chemical components or selected groups of components, to increase the up-time of the offset printing process to values of competing gravure printing, i.e. to approximately 90 to 95%. In accordance with the invention, for the first time, a method and a device are used in printing technology which continuously measure the concentrations of the individual components of the additive due to selective weakening of electromagnetic radiation, and regulate these to predetermined optimum values thereby preventing losses in processing liquid, as well as overdosing of individual components of the additive such that the printing process can be continuously carried out with high stability and availability at an optimum working point. The fact that the method can be operated not only with alcohol-free printing, i.e. with substitutes, but that the selectivity of the measurement and regulation of the additive can also be maintained in printing with the additional admixture of alcohol, (i.e. the alcohol does not falsify the measurement of concentrations of the individual components of the additive), is of main inventive importance. In accordance with the invention, the selective measurement of concentrations of the individual components or of groups of different chemical compounds is coupled with a dosing system which removes the various components from various containers via a system which consists of cycled valves and pumps, and guides them in a controlled manner to the dampening solution. This new method decisively optimizes offset printing with alcohol. Printing without alcohol is facilitated in a manner which permits long term processing, while thereby satisfying the economic boundary conditions. The fact that the new method permits individual, online adjustment of the dampening solution to the respective printing order, i.e. paper type, ink type, sheet speed, fundamental interactions between the ink and dampening solution as a central property of the offset process, prevents generally known problems, such as e.g. inadmissible deposits on the rubber blanket, undesired ink decomposition in the dampening solution, detrimental chemical attacks on the printing plates etc. In particular, the insufficient variation possibilities of the concentrations of the individual chemical components of ready-to-use additives can be arbitrarily extended by the new method such that permanent dampening solution change, in particular due to the above-mentioned search for better dampening solution additives, during standstill of the printing process for several hours and corresponding negative consequences for the disposal of the previously operated dampening solution and therefore also for the economics of the printing process are avoided by the new method.

In accordance with current prior art, dosing means are used for generating the processing liquid by volumetrically mixing the two or three components through control under fixed predetermined conditions and introducing them into the liquid circuit of the printing machine in accordance with the respective consumption, i.e. in accordance with discharge of the liquid through the paper to be printed. In addition to mixing stations which are operated by hand, systems with conventional dosing pumps are also currently used. A severe disadvantage of these systems is that neither malfunctions of the mixing means nor changes in the physical and/or chemical composition, e.g. due to chemical reactions or absorption or desorption processes by the printing ink, paper, the pipe conduit or machine modules, can be defined. In particular, evaporation processes produce considerable concentration errors in these classical dosing methods. The sensors for detecting the electrical conductance which are currently used as sole control instruments are unsuitable for quantitative measurement of the concentration of the respective additive or substitute due to the strong and varying soiling of the processing liquid. Moreover, the important conducting chemical components of the additives which permit printing cannot be detected through conductance measurement, since these substances cannot be dissociated in water.

The pH probe which has been introduced more or less as a standard in offset printing can at most be used as an indicator shortly before the functional collapse of the printing process, since the required strong chemical buffering of the processing liquid e.g. using citric acid, prevents change of the pH value even for large variations in the chemical composition.

The present invention therefore concerns a method and a device for realizing the method which permit qualitative, continuous measurement and regulation of the concentrations of the individual components of the respective additive or the substitute in a matrix of up to 20 chemical components without falsifying influence of other substances such as e.g. in particular alcohols, dirt, ink and paper particles, gas bubbles, salts from the paper and other impurities as are typical for offset printing. Moreover, the individual components must be measured and regulated with an accuracy between 10 ppm and 3.0%, depending on the substance. This problem could not be previously solved in any practical case. Scientific tests in accordance with the invention have mainly shown that the different chemical contents of a statically predetermined additive mixture are not consumed in proportion to the concentration, and consequently, the mixture changes during the course of the printing process, as the inks, the paper and also other effects produce a more or less selective depletion of the individual components. This particular situation in offset printing renders the present invention extremely valuable, since depletion effects are completely compensated for, irrespective of the customer order input into the printing machine. The present invention solves the above-stated objects i.a. in that the individual chemical components are continuously measured and are supplied to the dampening agent circuit in the form of pure, raw materials and/or as partial mixtures of several components, generally mixed with water, such that they easily dissolve in the dampening solution and, in particular, form no separate phases. In this way, chemical formulations may also be used which separate in a predetermined additive concentrate and therefore would not lead to a homogeneous solution. In accordance with the invention, the weakening of electromagnetic radiation during passage through the dampening solution is utilized for determining the concentration.

The invention is described below with reference to the drawing.

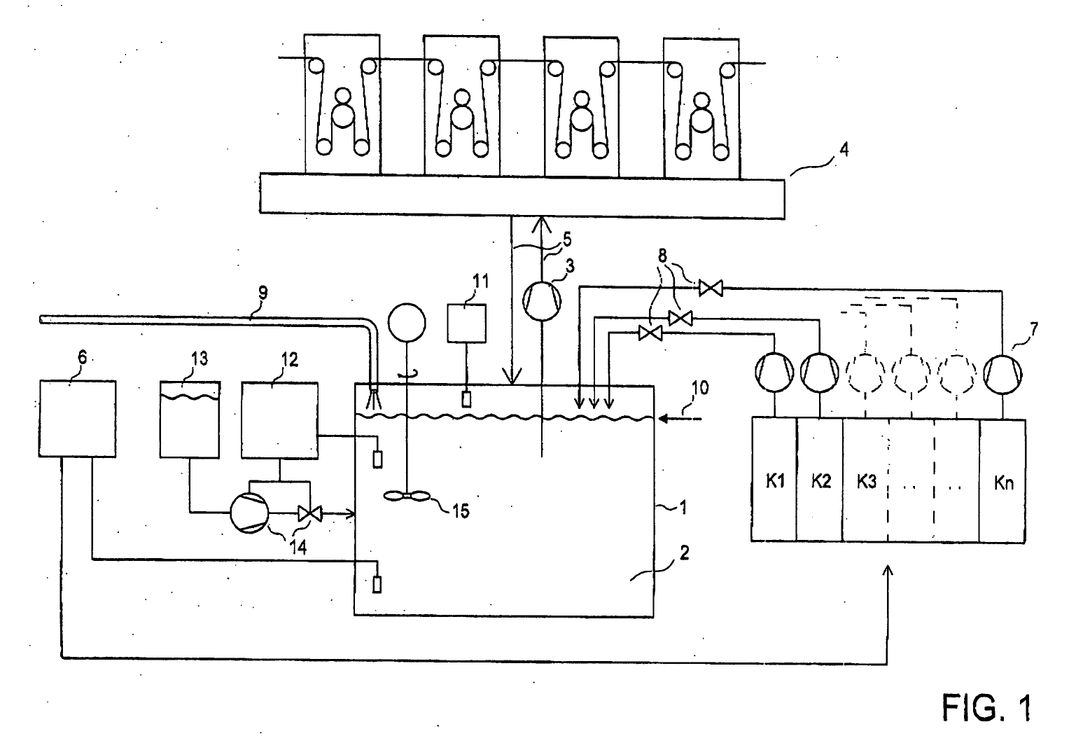

FIG. 1 shows the overall system which consists of measuring and control systems, printing machine and processing liquid circuit, wherein the various chemical components/component groups are dosed directly via the measuring and regulation device;

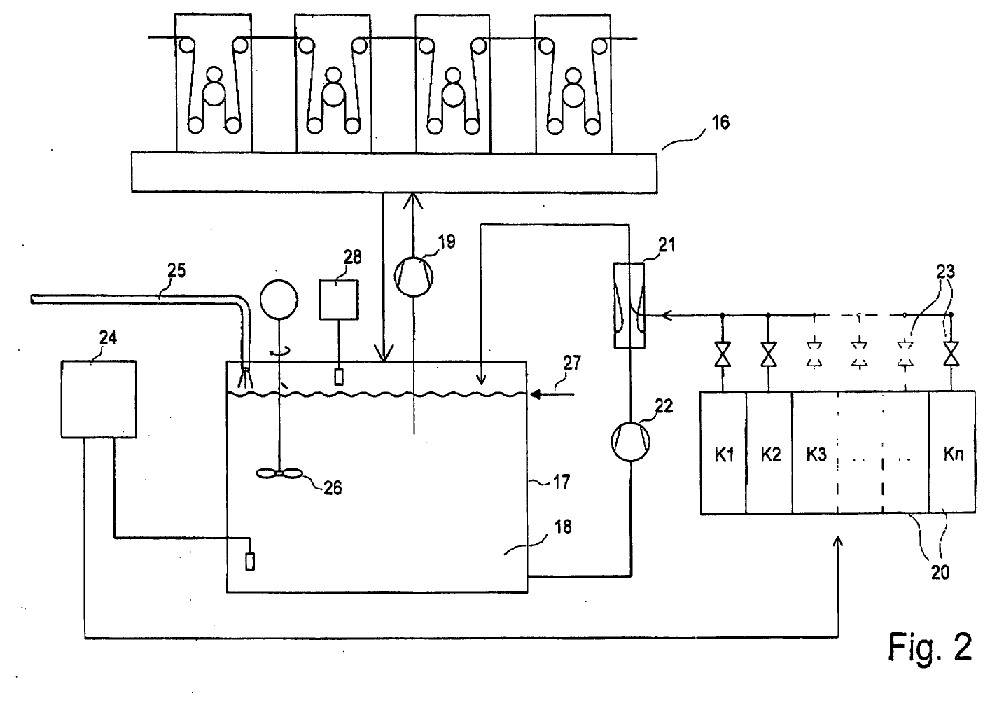

FIG. 2 shows an alternative design of the invention, wherein dosing is effected using a Venturi nozzle;

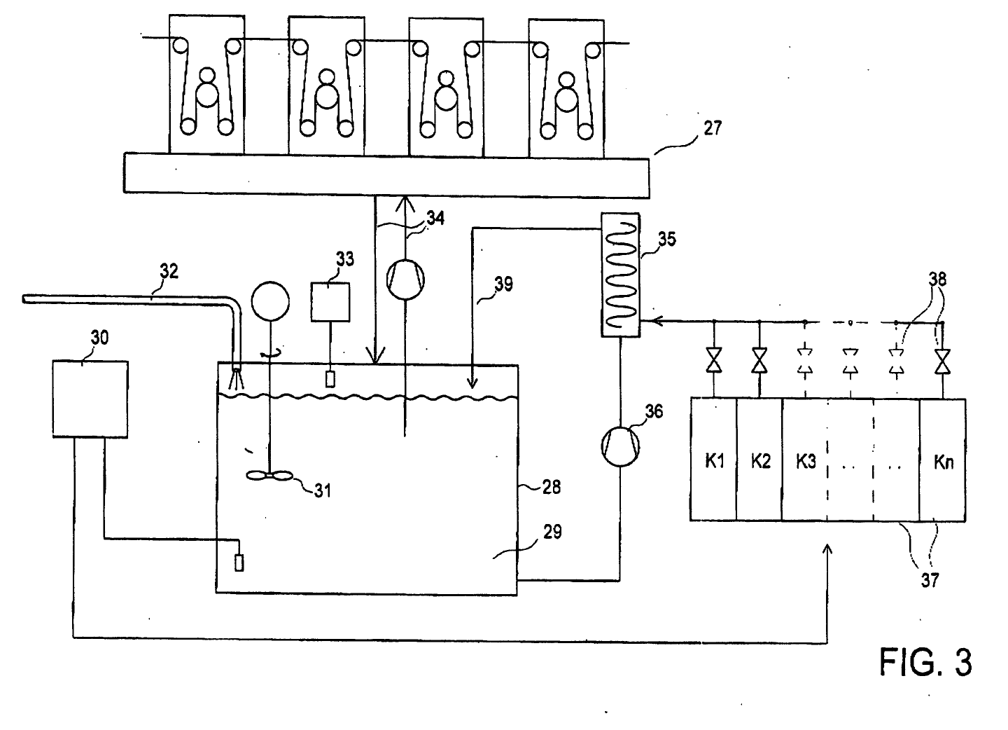

FIG. 3 shows an alternative design of the invention which is characterized in that the individual chemical components are guided through a static mixer;

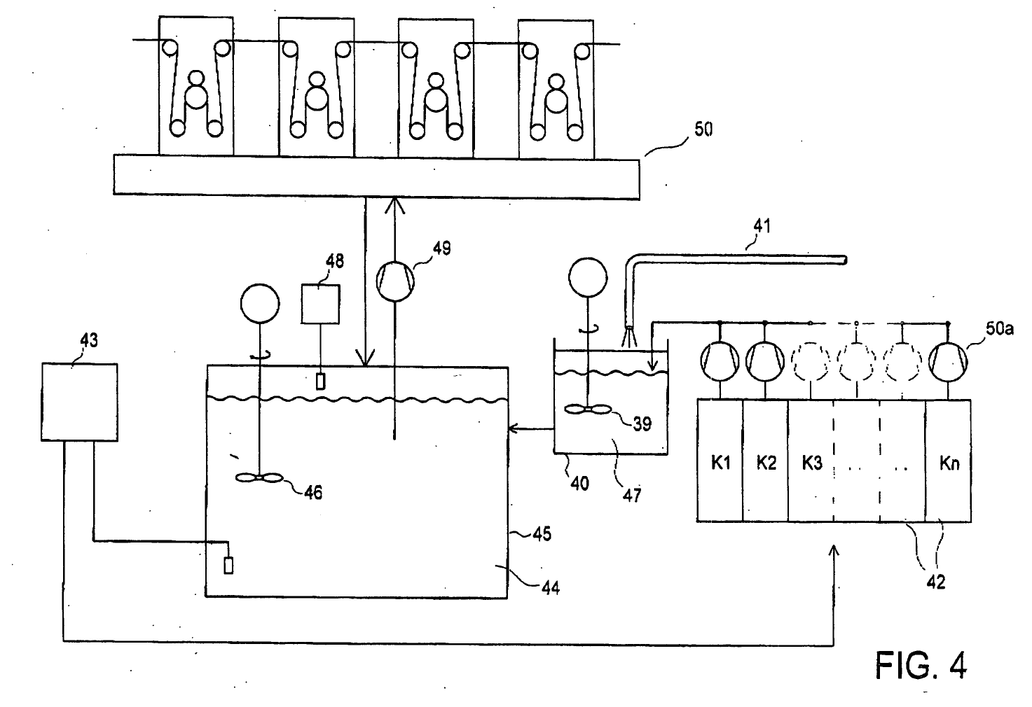

FIG. 4 shows a further system variant wherein previous mixing is effected in a separate container which is connected to the overall system, wherein the composition corresponds to the optimum mixing ratio;

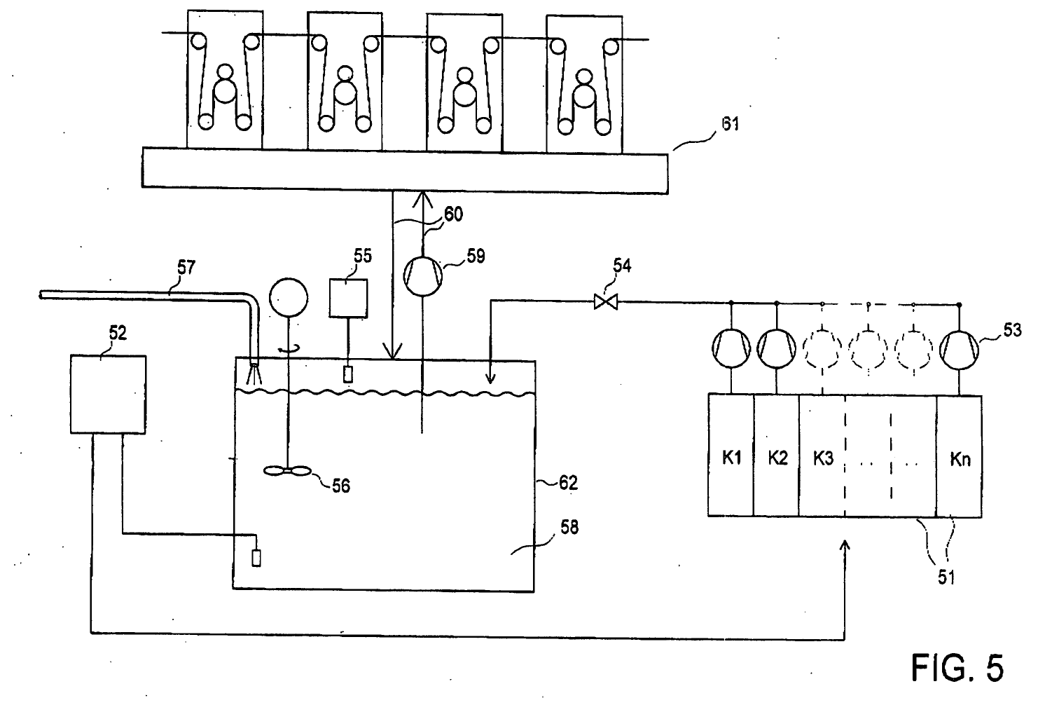

FIG. 5 shows a system, wherein the optimum composition is achieved via calibrated dosing pumps.

In accordance with FIG. 1, the processing liquid (2) contained in a tank (1) is circulated through the printing machine (4) and back to the tank via circulating pumps (3) and pipe conduits (5). The respective individual chemical component additive concentrations are continuously measured by a measuring system (6). The predetermined chemical components K1, K2, K3, . . . to Kn are fed into the processing liquid (2) via pumps (7) and valves (8). The respectively required different desired concentrations of the chemical components K1 to Kn are guaranteed in that the measuring system (6) continuously measures the actual concentrations and adds a corresponding amount of the respective component during regulation so that the actual value is equal to the predetermined desired value. This ensures that the additive components which are constantly consumed by the printing process or removed from the walls of the printing line through chemical reactions or physical absorption processes are added to the processing liquid (2) such that the actual values of the concentration of the additive are equal to the desired values predetermined by the printer and irrespective of the strength of the respective loss processes. The water loss in the processing liquid (2) is compensated for via a pipe conduit (9), wherein the fill level (10) is kept constant using a level measuring and regulation system (11) in accordance with the ultrasound echolot principle or another conventional method. If alcohol is used, its concentration in the processing liquid (2) is continuously measured by means of a further measuring and regulation means (12) which may also be integrated into a measuring system (6) suitable for other embodiments of the invention, and the alcohol loss caused substantially through evaporation is replaced from a supply container (13) via a unit comprising a valve and dosing pump (14) such that the desired and actual values are always the same and the up-time and quality of the printing process are also ensured when printing with alcohol. A stirring apparatus (15) is used to homogenize the processing liquid.

FIG. 2 shows a sketch of the inventive arrangement which comprises a printing machine (16), a dampening solution tank (17), dampening solution (18) with circulation (19) and chemical components K1 through Kn (20) which are operated via a Venturi nozzle (21) and a pump (22), which suctions chemical components K1 through Kn via valves (23) and feeds them into the dampening solution (18), wherein the concentrations of the chemical components are measured via the measuring and regulation system (24). The supply (25) of water with automatic level regulation and the stirring apparatus (26) correspond to the arrangements of FIG. 1.

FIG. 3 shows an overall arrangement which consists of a printing machine (27), a dampening solution tank (28), dampening solution (29), a measuring and regulation system (30), a stirring apparatus (31), water supply (32) including fill level control (33), dampening solution circulation (34), and an additional static mixer (35). The dampening solution (29) which is guided via the pump (36) in the circuit is mixed in the static mixer (35) with the chemical components K1 through Kn (37) which are supplied into the circuit (39) via the valves (38) such that both the measuring system (30) and the circuit (34) contain homogeneous liquid mixtures and the overall system of FIG. 3 provides optimum function.

FIG. 4 shows a version of the invention which differs from the previous figures and which is characterized by previous mixing of the chemical components K1 through Kn (42) in a mixing container (40) via pumps (50a) with a water supply (41). The arrangement considerably reduces the regulation process of the measuring system (43) to obtain the respective desired concentrations of the chemical components K1 through Kn (42), such that the composition of the dampening solution (44) in the dampening solution tank (45) always has the predetermined desired values, even over brief time intervals. Moreover, analogously to the stirring apparatus (46) in the dampening solution tank, a homogenizing means (39) is also used in the pre-mixing container (40).

The homogenizing means (35) may also be a static mixer in accordance with FIG. 3. To prevent possible fill level problems during feeding of the pre-mixed liquid (47) into the dampening solution tank (45), the use of a sensor (48), preferably in accordance with the ultrasound echolot principle, is of great importance. Circulation (49) of the dampening solution (44) to the printing machine (50) via the pump (49) is effected analogously to FIGS. 1 through 3.

FIG. 5 shows the most simple variant in accordance with the invention, wherein the chemical components K1 through Kn (51) are added via a valve (54) using calibrated dosing pumps (53) regulated by the measuring system (52) in accordance with the respective desired value of the individual components. The fill level measurement (55) and the stirring apparatus (56) permit homogeneous mixing of the dampening solution (58) in combination with the water supply (57) which circulates in the circuit (60) between printing machine (61) and dampening solution cooling device (62) via the circulating pump (59).

1-16. cancelled

17. A method for direct, selective measurement and control of concentrations of individual chemical components of chemical additives or of alcohol substitutes in processing liquids for offset printing, the method comprising the steps of:
a) continuously measuring concentrations of the individual chemical components or groups thereof; and
b) redosing the individual component or groups to obtain respective desired values thereof.

18. The method of claim 17, wherein the chemical components are located in individual containers and redosing is effected via a measuring system which continuously measures concentrations of the individual components or groups thereof, and effects subsequent dosing of the individual components via a control loop.

19. The method of claim 18, wherein redosing of the individual chemical components or groups from the individual containers is effected via pumps, each in series with a valve.

20. The method of claim 17, wherein the individual components or groups are suctioned into a dampening solution circuit using a Bernouilli nozzle.

21. The method of claim 17, wherein mixing of dampening solution and the individual components or groups is optimized by a static mixer.

22. The method of claim 17, wherein the individual chemical components or groups are premixed with water in a premixing container and a liquid content of the premixing container is transferred into a dampening solution container.

23. The method of claim 18, wherein the individual chemical components or groups are each dosed from each individual container via separate individual pumps having a common downstream valve.

24. A device for direct, selective measurement and control of concentrations of individual chemical components, chemical additives, or of alcohol substitutes in processing liquids for offset printing, the device comprising:
means for continuously measuring concentrations of the individual chemical components or groups thereof; and
means for redosing the individual components or groups to obtain respective desired values thereof.

25. The device of claim 24, wherein the individual chemical components, K1 through Kn, are re-fed via pumps such that actual concentrations are equal to desired concentrations.

26. The device of claim 25, wherein a Bernouilli nozzle is used as a pump and is operated by a partial flow of a dampening solution which is circulated by a pump.

27. The device of claim 25, wherein the chemical components K1 through Kn are homogeneously mixed with dampening solution using a static mixer in a circuit driven by a pump.

28. The device of claim 25, wherein the individual chemical components K1 through Kn are prepared in a premixing container with water from a water conduit via pumps and a resulting mixture is subsequently supplied to a main container.

29. The device of claim 25, wherein the individual chemical components K1 through Kn are dosed into a dampening solution via separate pumps and a downstream valve.

30. The device of claim 25, wherein an additional measuring and regulating unit continuously measures a concentration of alcohol in a dampening solution and redoses alcohol from an alcohol reservoir via a pump and a downstream valve.

31. The device of claim 25, wherein a fill level is detected with a sensor and the fill level is kept constant using a control loop.

32. The device of claim 31, wherein an ultrasound unit is used as a fill level sensor and operates in accordance with an echolot principle.

33. The device of claim 25, wherein a dampening solution is homogenized using a stirring apparatus.
